(19) United States
(12) Patent Application Publication
(10) Pub. No.: US 2018/0060556 A1
(43) Pub. Date: Mar. 1, 2018

(54) AUTHENTICATION METHOD, MOBILE DEVICE, AND STORAGE MEDIUM

(71) Applicant: FUJITSU LIMITED, Kawasaki-shi (JP)

(72) Inventor: Hiroshi FUJINO, Fuchu (JP)

(73) Assignee: FUJITSU LIMITED, Kawasaki-shi (JP)

(21) Appl. No.: 15/678,106

(22) Filed: Aug. 15, 2017

(30) Foreign Application Priority Data
Aug. 24, 2016 (JP) 2016-164138

(51) Int. Cl. G06F 21/32; G06K 9/00

(52) U.S. Cl. CPC G06F 21/32; H04W 12/06; G06K 9/00617

(57) ABSTRACT

An authentication method executed by a processor included in a mobile device having a camera, the authentication method includes displaying an image captured by the camera and including irises of a user on a screen of the mobile device based on a position of a displayed guide image specifying positions of eyes; calculating, based on positional relationships between light spots and the regions of the irises, when the light spots included in the image overlap regions of the irises, shift vectors of the light spots when the light spots are shifted until the light spots do not overlap the regions of the irises; and moving the displayed guide image in a movement direction determined based on the shift vectors and executing authentication on the user using the irises displayed based on the position of the displayed guide image after the movement of the guide image.

### CROSS-REFERENCE TO RELATED APPLICATION

This application is based upon and claims the benefit of priority of the prior Japanese Patent Application No. 2016-164138, filed on Aug. 24, 2016, the entire contents of which are incorporated herein by reference.

### FIELD

The embodiments discussed herein are related to an authentication method, a mobile device, and a storage medium.

### BACKGROUND

In recent years, mobile devices, which are smartphones, mobile phones, and the like and execute iris authentication using irises within eyes as an authentication method to be executed to inhibit personal information from leaking to third parties, are widely used. The iris authentication is a method of executing authentication by capturing an image of eyes of a user using a camera included in a mobile device, extracting information of irises from the captured image of the eyes, and comparing the extracted information of the irises with a previously registered iris template. As related art, Japanese Laid-open Patent Publication No. 2005-025439 and Japanese Laid-open Patent Publication No. 2003-037766 are disclosed, for example.

Since mobile devices are used while being carried, locations at which the mobile devices are used are not fixed. Thus, when a mobile device is used and executes iris authentication, a recognition rate that indicates the probability of recognizing irises may easily depend on the amount of light. Especially, when a user wears glasses, circular images caused by light reflected on lenses of the glasses may be displayed while overlapping regions of irises, depending on the angle of light with which the user is illuminated, and the iris authentication may fail. In view of the aforementioned fact, it is desirable to execute authentication with high accuracy, regardless of a location at which the iris authentication is executed.

### SUMMARY

According to an aspect of the invention, an authentication method executed by a processor included in a mobile device having a camera, the authentication method includes displaying an image captured by the camera and including irises of a user on a screen of the mobile device based on a position of a displayed guide image specifying positions of eyes; calculating, based on positional relationships between light spots and the regions of the irises, when the light spots included in the image overlap regions of the irises, shift vectors of the light spots when the light spots are shifted until the light spots do not overlap the regions of the irises; and moving the displayed guide image in a movement direction determined based on the shift vectors and executing authentication on the user using the irises displayed based on the position of the displayed guide image after the movement of the guide image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an exemplary functional block diagram of a mobile device according to a first embodiment;

FIG. 2 is a diagram illustrating an example of a hardware configuration of the mobile device;

FIG. 3 is an exemplary front view of the mobile device;

FIG. 4 is a flowchart of an example of an iris authentication method according to the first embodiment;

FIGS. 5A and 5B are diagrams describing an example of a method of acquiring images of both eyes;

FIG. 6 is a diagram describing information to be acquired by a region information acquirer;

FIGS. 7A, 7B, 7C, and 7D are diagrams describing the calculation of the minimum shift vectors;

FIG. 8 is a flowchart of a procedure for a process of S108;

FIG. 9 is a diagram describing a method of calculating a shift distance of a light spot;

FIGS. 10A and 10B are diagrams illustrating states in which a user's facial image captured by an infrared camera is displayed on a screen;

FIGS. 11A and 11B are diagrams illustrating a state in which a user's facial image captured by the infrared camera is displayed on the screen in the first embodiment;

FIGS. 12A and 12B are diagrams illustrating shifts of light spots on the screen when the mobile device is moved;

FIGS. 13A, 13B, and 13C are diagrams illustrating an example of shifts of the light spots when specified regions of a displayed guide image are moved;

FIG. 14 is a flowchart of an example of an iris authentication method according to a second embodiment; and

FIG. 15 is a diagram describing a method of calculating a shift distance of a light spot according to the second embodiment.

### DESCRIPTION OF EMBODIMENTS

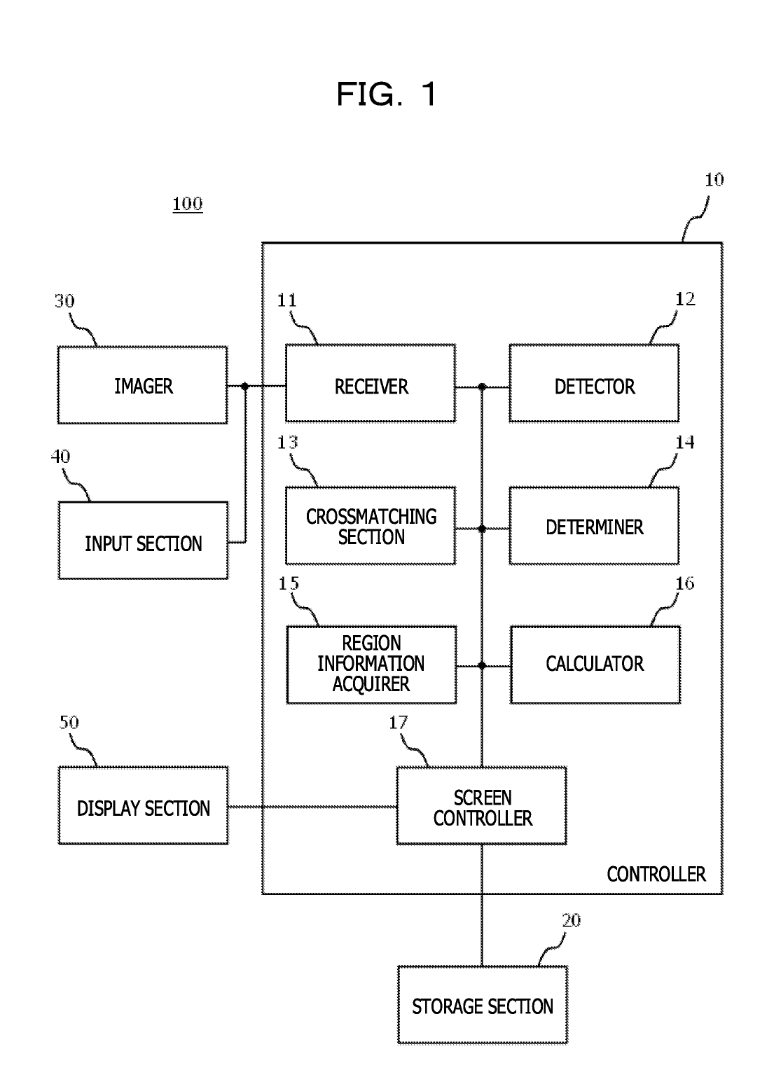

Hereinafter, embodiments are described in detail with reference to FIGS. 1 to 15.

### First Embodiment

FIG. 1 is an exemplary functional block diagram of a mobile device according to a first embodiment. As illustrated in FIG. 1, a mobile device 100 includes a controller 10, a storage section 20, an imager 30, an input section 40, and a display section 50. Functions of the sections are described below.

The controller 10 is hardware that manages processes of the whole mobile device 100. The controller 10 includes a receiver 11, a detector 12, a crossmatching section 13, a determiner 14, a region information acquirer 15, a calculator 16, and a screen controller 17.

The receiver 11 receives an image captured by the imager 30 and indicating eyes of a user. The receiver 11 receives various commands from the user via the input section 40.

The detector 12 detects images of irises from the image received from the receiver 11 and indicating the eyes. The irises are films between corneas of the eyes and crystalline lenses of the eyes. The irises are torus-shape portions that are within regions of black eyes and outside pupils located at the centers of the black eyes. The torus-shape portions include patterns that vary from person to person. The detector 12 has a function of detecting, from the image received from the receiver 11 and indicating eyes, images of light (hereinafter referred to as light spots) reflected on lenses of glasses.

The cross-matching section 13 crossmatches the patterns of the irises detected by the detector 12 with a previously registered template.

The determiner 14 executes various determination processes in the mobile device 100. For example, if an iris of one of the eyes matches the template or the irises of the eyes match the template, the determiner 14 determines that iris authentication has been successful.

The region information acquirer 15 acquires, as region information, information of coordinates of the centers of regions of the irises detected by the detector 12 and coordinates of the centers of regions of the light spots detected by the detector 12 and information of the radii of the regions of the irises and the radii of the regions of the light spots.

The calculator 16 uses the information acquired by the region information acquirer 15 and indicating the coordinates and the radii to calculate shift vectors of the light spots when the light spots overlapping the regions of the irises are shifted until the light spots do not overlap the regions of the irises. A method of calculating the shift vectors is described later. Hereinafter, regions of the entire black eyes are referred to as “regions of irises” for convenience sake of description.

The screen controller 17 executes control to move a guide image specifying the positions of the eyes and displayed on a screen of the display section 50 upon the iris authentication by the user, based on the shift vectors, calculated by the calculator 16, of the light spots. Details of the guide image are described later.

Next, the storage section 20, the imager 30, the input section 40, and the display section 50 that are connected to the controller 10 are described.

The storage section 20 is hardware that stores information and a program that are used for processes to be executed by the controller 10. For example, the storage section 20 stores various iris templates to be used for the authentication. The storage section 20 may be configured with one or more storage devices based on the use of the storage section 20, a requested storage capacity of the storage section 20, and the like.

The imager 30 is a camera that captures an image of the eyes of the user. The imager 30 transmits the captured image of the eyes to the receiver 11 of the controller 10.

The input section 40 is an input interface that receives commands input from the user. The input section 40 transmits the commands from the user to the receiver 11.

The display section 50 is connected to the screen controller 17 and displays an image in accordance with control by the screen controller 17.

Next, a hardware configuration of the mobile device 100 is described.

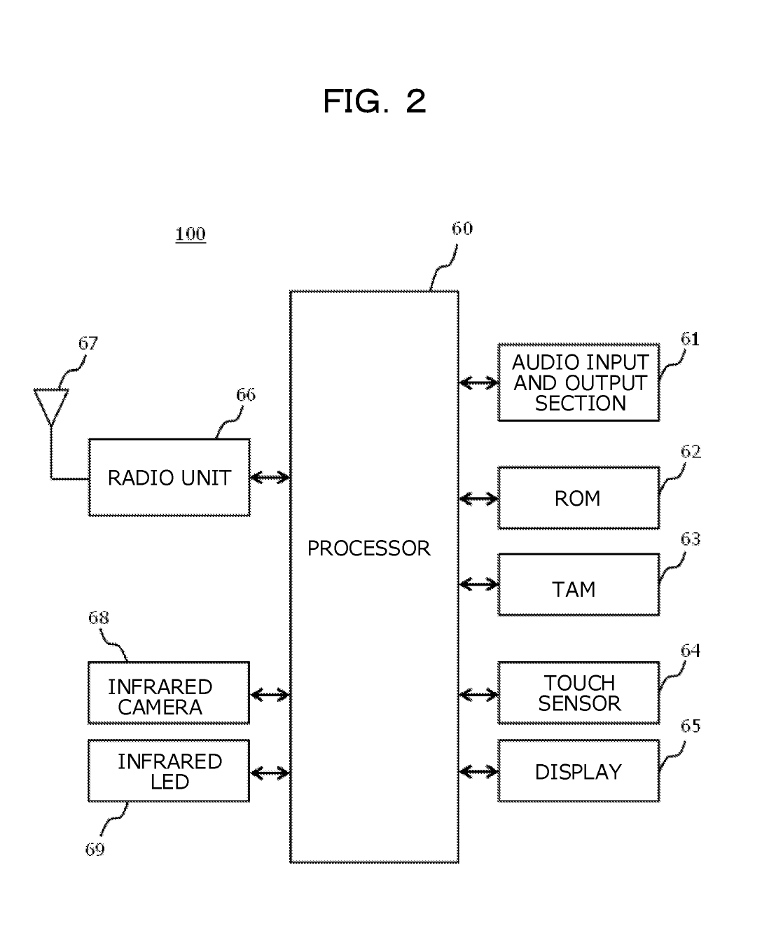

FIG. 2 is a diagram illustrating an example of the hardware configuration of the mobile device. As illustrated in FIG. 2, the mobile device 100 includes a processor 60, an audio input and output unit 61, a read only memory (ROM) 62, a random access memory (RAM) 63, a touch sensor 64, a display 65, a radio unit 66, an antenna 67, an infrared camera 68, and an infrared LED 69.

The processor 60 is an arithmetic processing device that executes a process of controlling operations of the whole mobile device 100. The processor 60 may be achieved by a central processing unit (CPU) or a micro processing unit (MPU), for example. Alternatively, the processor 60 may be configured with a multi-core processor or multiple processors. The processor 60 is an example of the controller 10 illustrated in FIG. 1.

The audio input and output unit 61 includes an audio input device such as a microphone or an audio output device such as a speaker or includes an audio input device such as a microphone and an audio output device such as a speaker, for example. If the mobile device 100 is a mobile phone such as a smartphone for making a call, the audio input and output unit 61 receives voice input from the user and outputs received voice.

The ROM 62 is a nonvolatile storage device that stores a program (including an information processing program) for controlling operations of the mobile device 100. The RAM 63 is a volatile storage device that may be used as a work area upon the execution of the program. The RAM 63 may be included in the processor 60. The ROM 62 and the RAM 63 are an example of the storage section 20 illustrated in FIG. 1.

The touch sensor 64 is an input device to be used by the user to touch an operation screen with a finger or the like and operate the mobile device 100. The touch sensor 64 may be mounted on the display 65 (described below) while overlapping the display 65 described below, for example. The touch sensor 64 is an example of the input section 40 illustrated in FIG. 1.

The display 65 displays an image on a screen of the display 65. The display 65 may display images of icons and texts and an image captured by the infrared camera 68. The display 65 is achieved by a liquid crystal display, a plasma display, an organic electroluminescence (EL) display, or the like, for example. The display 65 is an example of the display section 50 illustrated in FIG. 1.

The radio unit 66 is hardware that receives a signal via the antenna 67 and outputs the received signal to the processor 60. The radio unit 66 has a function of transmitting, via the antenna 67, a signal generated in a process executed by the processor 60. For example, if the mobile device 100 is a mobile phone, the radio unit 66 transmits a signal indicating voice of the user and receives a signal indicating received voice.

The infrared camera 68 is an electronic unit that captures an image of the eyes of the user. The infrared camera 68 is an example of the imager 30 illustrated in FIG. 1.

The infrared LED 69 is an electronic unit that emits an infrared ray. The mobile device 100 uses the infrared camera 68 and the infrared LED 69 to capture an image of the eyes of the user. Since the infrared ray is used, the iris authentication may be appropriately executed even in a dark region.

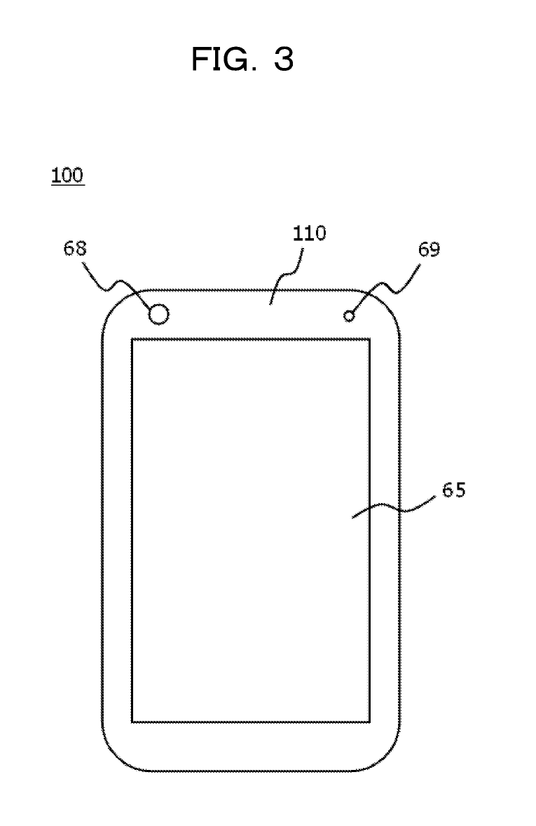

FIG. 3 is an exemplary front view of the mobile device. Units that are illustrated in FIG. 3 and the same as those illustrated in FIG. 2 are indicated by the same reference numbers as those illustrated in FIG. 2. As illustrated in FIG. 3, the mobile device 100 includes a body 110, the display 65, the infrared camera 68, and the infrared LED 69.

The display 65 is mounted on the body 110 so that the display 65 is exposed from a top surface of the body 110. In the example illustrated in FIG. 3, a screen of the display 65 is formed in a rectangular shape, but may be formed in a quadrangular shape and have rounded corners and straight sides as parts of the contour of the screen of the display 65. The infrared camera 68 and the infrared LED 69 are arranged on the upper side of the display 65 so that there are gaps between the display 65 and the infrared camera 68 and between the display 65 and the infrared LED 69. The display 65, the infrared camera 68, and the infrared LED 69 are arranged on the same surface of the mobile device 100.

Next, an authentication method to be executed by the mobile device 100 illustrated in FIG. 1 according to the first embodiment is described.

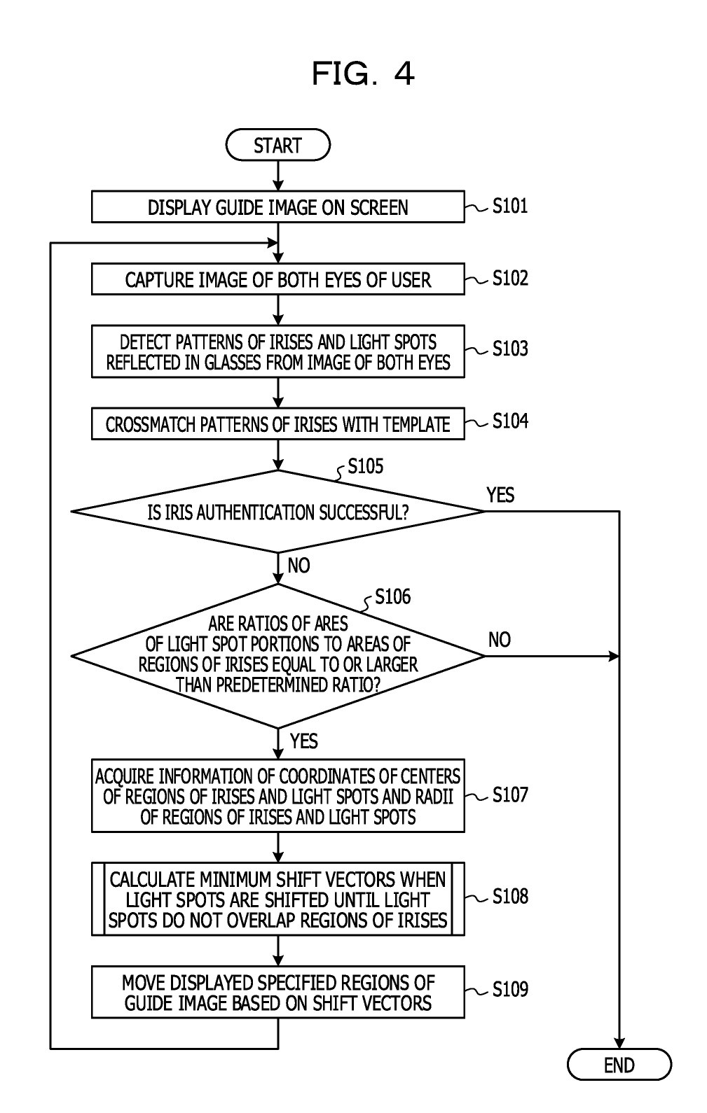

FIG. 4 is a flowchart of an example of the iris authentication method according to the first embodiment. The flowchart assumes that the iris authentication method is executed on the user wearing glasses. It is assumed that the shapes of light spots are exact circles.

First, the display section 50 displays the guide image on the screen (in S101). The guide image is an image to be displayed to guide the user so that the user places image portions displayed on the screen and indicating the eyes of the user in specified regions on the screen upon the capture of an image of the eyes of the user. Specifically, by displaying the guide image, the positions of the specified regions are specified on the screen. In the first embodiment, an image that is not in a semitransparent dark image that is not in the specified regions and looks like being masked is exemplified as the guide image.

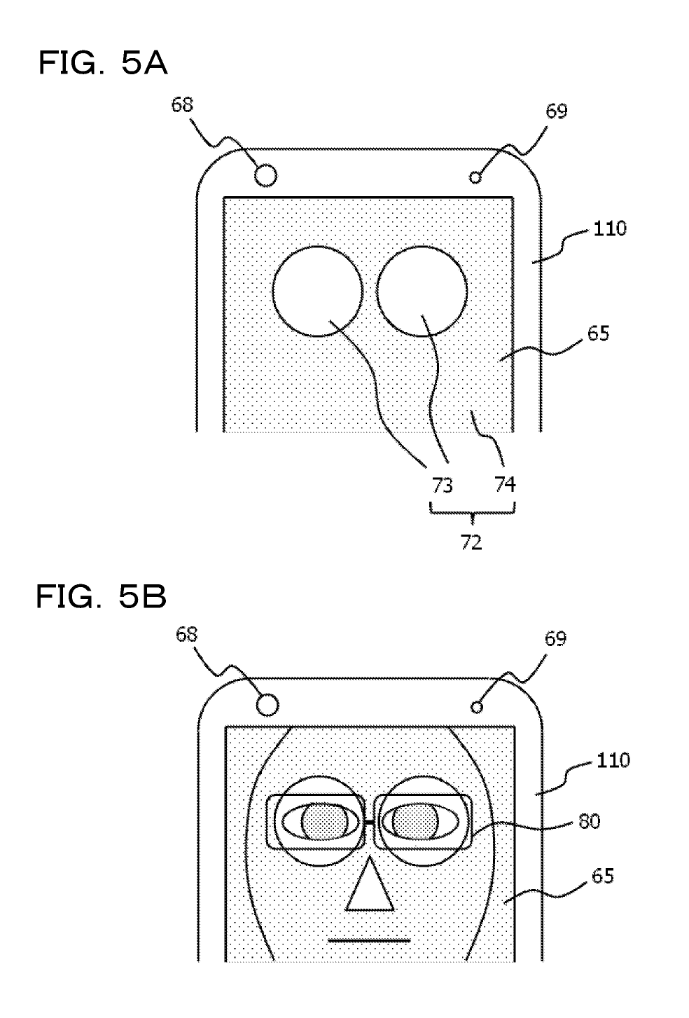

FIGS. 5A and 5B are diagrams describing an example of a method of acquiring the image of the eyes of the user. FIG. 5A is a diagram illustrating an example of the guide image. As illustrated in FIG. 5A, a guide image 72 includes two specified circular regions 73 specifying the positions of both eyes and a mask region 74 that is not in the specified regions 73. The mask region 74 is displayed in a color darker than the specified regions 73. A gap between the two circular regions and the areas of the two circular regions may be changed based on the size of the face of the user. The specified regions 73 may be formed in a polygonal shape such as a quadrangular shape, a rectangular shape, or the like, for example.

During the time when the display section 50 displays the guide image on the screen, the imager 30 captures an image of both eyes of the user (in S102). FIG. 5B is a diagram illustrating the positions of both eyes whose image portions are placed based on the guide image 72. In S102, the receiver 11 receives the image indicating both eyes and captured when the image portions of both eyes of the user wearing glasses 80 are placed in the specified regions 73 of the guide image 72. Then, the detector 12 detects, from the image portions of both eyes, patterns of the irises and light spots reflected in the glasses (in S103). As a processing method of recognizing the irises within the image, the Daugman's algorithm may be used, for example.

Subsequently, the crossmatching section 13 crossmatches the detected patterns of the irises with a user's iris pattern template previously registered in the storage section 20 (in S104).

Then, the determiner 14 determines whether or not the iris authentication has been successful (in S105). If an iris of one of the eyes matches the template or the irises of the eyes match the template, the determiner 14 determines that the iris authentication has been successful. If the determiner 14 determines that the iris authentication has been successful (Yes in S105), the determiner 14 terminates the iris authentication process. On the other hand, if the determiner 14 determines that the iris authentication has not been successful (No in S105), the determiner 14 determines whether or not ratios of the areas of light spot portions included in the regions of the light spots and overlapping the regions of the irises to the areas of the regions of the irises are equal to or higher than a predetermined ratio (in S106). In S106, the calculator 16 calculates the areas of the regions of the irises exposed from eyelids and the areas of the light spot portions overlapping the regions of the irises. Then, the calculator 16 calculates the ratios of the areas of the light spot portions overlapping the regions of the irises to the areas of the regions of the irises. Then, the determiner 14 determines whether or not the calculated ratios are larger than a set threshold. The threshold is in a range of 0.1 to 0.2, for example.

If the determiner 14 determines that the ratios of the areas of the light spot portions overlapping the regions of the irises to the areas of the regions of the irises are smaller than the predetermined ratio (No in S106), the determiner 14 determines that the failure of the iris authentication is not caused by the light spots, and the determiner 14 terminates the iris authentication process. On the other hand, if the determiner 14 determines that the ratios of the areas of the light spot portions overlapping the regions of the irises to the areas of the regions of the irises are equal to or larger than the predetermined ratio (Yes in S106), the determiner 14 determines that the failure of the iris authentication is caused by the light spots. Then, the region information acquirer 15 acquires, from the regions of the irises detected by the detector 12 and the light spots detected by the detector 12, information of coordinates of the centers of the regions of the irises, coordinates of the centers of the regions of the light spots, the radii of the regions of the irises, and the radii of the regions of the light spots (in S107).

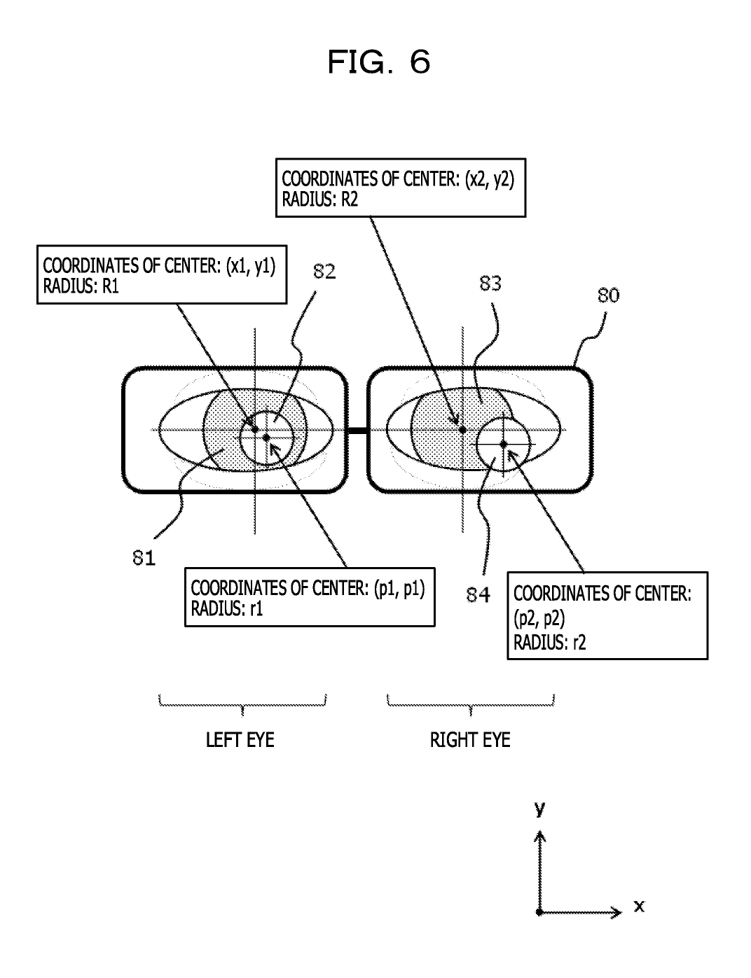

FIG. 6 is a diagram describing the information acquired by the region information acquirer. FIG. 6 illustrates an image indicating both eyes and displayed on the screen of the display section 50 of the mobile device 100. The image illustrated in FIG. 6 includes regions 81 and 83 of the irises within both eyes, light spots 82 and 84 displayed and overlapping the regions 81 and 83, and an image 80 of the glasses. The display section 50 mirror reverses and displays the captured image on the screen, as described later. Thus, in the image displayed on the screen and indicating both eyes, an eye displayed on the right side of the image indicates the right eye, and an eye displayed on the left side of the image indicates the left eye. The region information acquirer 15 executes the process of S107 using the image before the mirror reversal. The process of S107, however, is described below using the image displayed on the screen and indicating both eyes for convenience sake.

In S107, the region information acquirer 15 acquires coordinates (x1, y1) of the center of the region of the iris of the left eye, the radius R1 of the region of the iris of the left eye, coordinates (p1, q1) of the center of a light spot overlapping the region of the left eye, and the radius r1 of the light spot overlapping the region of the iris of the left eye. The region information acquirer 15 acquires coordinates (x2, y2) of the center of the region of the iris of the right eye, the radius R2 of the region of the iris of the right eye, coordinates (p2, q2) of the center of a light spot overlapping the region of the iris of the right eye, and the radius r2 of the light spot overlapping the region of the right eye.

After the process of S107, the calculator 16 uses the information acquired by the region information acquirer 15 and indicating the centers and the radii to calculate the minimum shift vectors of the light spots when the light spots overlapping the regions of the irises are shifted until the light spots do not overlap the regions of the irises (in S108).

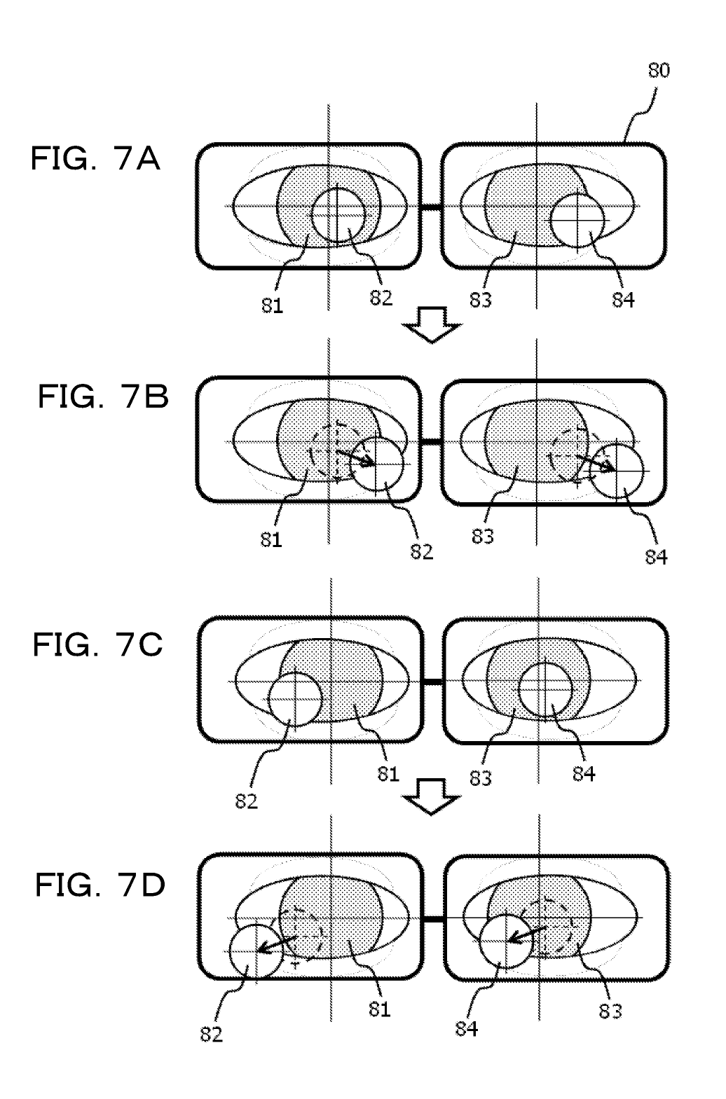

FIGS. 7A, 7B, 7C, and 7D are diagrams describing the calculation of the minimum shift vectors. FIG. 7A illustrates an example of positional relationships between the regions of the irises and the light spots. FIG. 7B illustrates a state when the two light spots illustrated in FIG. 7A are shifted by the same distance in a predetermined direction. FIG. 7C illustrates another example of the positional relationships between the regions of the irises and the light spots. FIG. 7D illustrates a state when the two light spots illustrated in FIG. 7C are shifted by the same distance in a predetermined direction. Arrows illustrated in FIGS. 7B and 7D indicate shift vectors.

In the example illustrated in FIG. 7A, when the two light spots 82 and 84 are shifted by the same distance, the light spot 84 that has previously overlapped the region 83 of the iris of the right eye is removed from the region 83 of the iris, but the light spot 82 overlapping the region 81 of the iris of the left eye still overlaps the region 81 of the iris, as illustrated in FIG. 7B. In the example illustrated in FIG. 7A, it is apparent from this that the shift distance of the light spot 84 overlapping the region 83 of the iris of the right eye is shorter than the shift distance of the light spot 82 overlapping the region 81 of the iris of the left eye.

In the example illustrated in FIG. 7C, when the two light spots 82 and 84 are shifted by the same distance, the light spot 82 that has previously overlapped the region 81 of the iris of the left eye is removed from the region 81 of the iris, but the light spot 84 overlapping the region 83 of the iris of the right eye still overlaps the region 83 of the iris, as illustrated in FIG. 7D. In the example illustrated in FIG. 7C, it is apparent from this that the shift distance of the light spot 82 overlapping the region 81 of the iris of the left eye is shorter than the shift distance of the light spot 84 overlapping the region 83 of the iris of the right eye.

In this manner, when the light spots are shifted until the light spots do not overlap the regions of the irises, which one of the shift distance of the light spot 82 that has overlapped the left eye and the shift distance of the light spot 84 that has overlapped the right eye is shorter is determined based on the positional relationships between the regions of the irises displayed on the screen and the light spots displayed on the screen. A procedure for the process of S108 is described below.

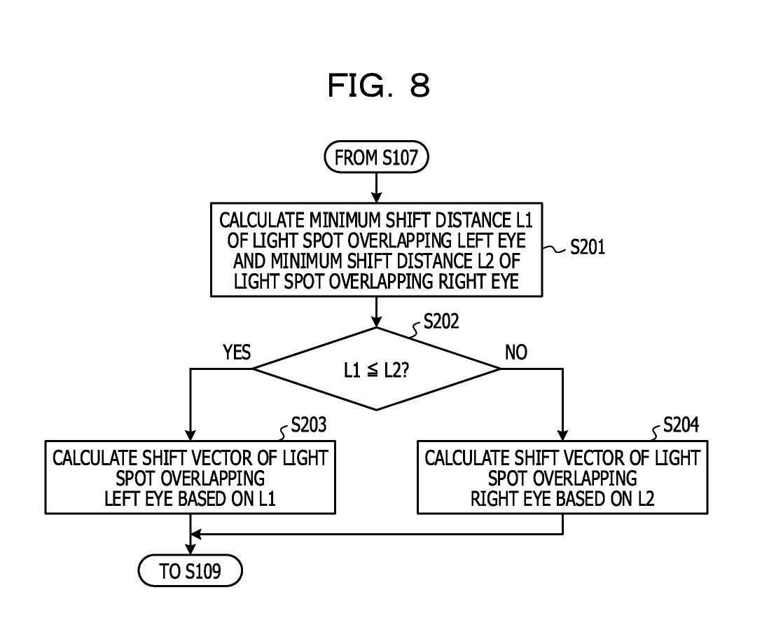

FIG. 8 is a flowchart of the procedure for the process of S108.

First, the calculator 16 uses the information acquired by the region information acquirer 15 and indicating the coordinates of the centers and the radii to calculate the minimum shift distance L1 of the light spot 82 when the light spot 82 overlapping the region 81 of the iris of the left eye is shifted until the light spot 82 does not overlap the region 81 of the iris. In addition, the calculator 16 uses the information acquired by the region information acquirer 15 and indicating the coordinates of the centers and the radii to calculate the minimum shift distance L2 of the light spot 84 when the light spot 84 overlapping the region 83 of the iris of the right eye is shifted until the light spot 84 does not overlap the region 83 of the iris (in S201).

Distances by which the light spots overlapping the regions of the irises are shifted in a direction from the centers of the regions of the irises to the centers of the light spots until the light spots do not overlap the regions of the irises are the minimum shift distances. After the light spots start to be shifted and cross outer circumferences of the regions of the irises, the light spots become externally tangent to the regions of the irises. When the light spots become externally tangent to the regions of the irises, the light spots do not overlap the regions of the irises for the first time. When the light spots are externally tangent to the regions of the irises, distances between the centers of the regions of the irises and the centers of the light spots are equal to the sums of the radii of the regions of the irises and the radii of the light spots. In other words, if the distances between the centers of the regions of the irises and the centers of the light spots are larger than the sums of the radii of the regions of the irises and the radii of the light spots, the light spots do not overlap the regions of the irises. The minimum shift distances of the light spots are distances by which the light spots are shifted in time periods from the start of the shifts of the light spots to time when the distances between the centers of the regions of the irises and the centers of the light spots become equal to the sums of the radii of the regions of the irises and the radii of the light spots.

In consideration of the aforementioned fact, a method of calculating the shift distance of the light spot overlapping the left eye is described using parameters of the coordinates and radii illustrated in FIG. 6.

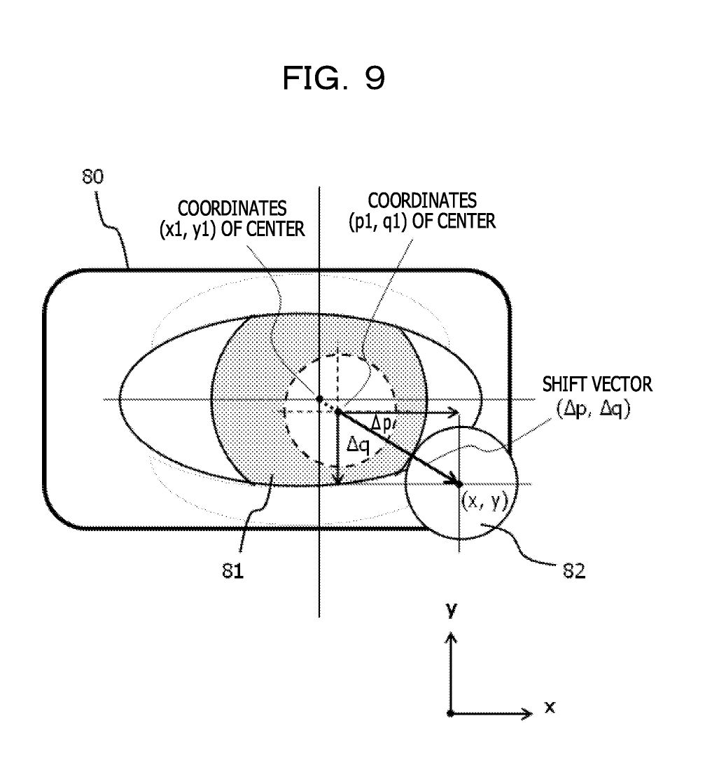

FIG. 9 is a diagram describing the method of calculating the shift distance of the light spot according to the first embodiment. FIG. 9 illustrates an image of the left eye that is displayed on the screen of the display section 50 of the mobile device 100. FIG. 9 illustrates a state when the light spot 82 is shifted by the minimum shift distance from the state illustrated in FIG. 6 until the light spot 82 does not overlap the region 81 of the iris and becomes externally tangent to the region 81 of the iris. The light spot 82 before the shift is indicated by a dotted line. Coordinates of the center of the region 81 of the iris are (x1, y1), while coordinates of the center of the light spot 82 before the shift are (p1, q1). Coordinates of the center of the spot light 82 after the spot light 82 is shifted by the minimum shift distance are (x, y). The description with reference to FIG. 9 assumes that, in an xy coordinate system having its origin at the center of the region 81 of the iris, the light spot 82 is shifted in an x-axis positive direction and a y-axis negative direction in the fourth quadrant of the xy coordinate system. Specifically, it is assumed that x>p1>x1 and y<q1<y1.

As illustrated in FIG. 9, if a shift distance of the light spot 82 in the x axial direction is Δp and a shift distance of the light spot 82 in the y axial direction is Δq, a shift vector of the light spot 82 is expressed by (Δp, Δq).

In this case, x and y are expressed by Equations 1.

x=p1+Δp, y=q1+Δq 1

If the distance between the center of the region 81 of the iris and the center of the light spot 82 after the light spot 82 is shifted by the minimum shift distance is equal to the sum of the radius R1 of the region 81 of the iris and the radius r1 of the light spot 82, the following Equation 2 is established.

{square root over (x−x1)²+(y−y1)²)}=R1+r1 2

When the light spot 82 is shifted in a direction from the center of the region 81 of the iris to the center of the light spot 82, the inclination of a straight line extending from the center of the region 81 of the iris to the center of the light spot 82 before the shift is the same as the inclination of a straight line extending from the center of the region 81 of the iris to the center of the light spot 82 after the light spot 82 is shifted by the minimum shift distance, and the following Equation 3 is established.

$$\frac{y - y 1}{x - x 1} = \frac{q 1 - y 1}{p 1 - x 1} \qquad 3$$

When Equations 2 and 3 are solved, x and y are calculated according to Equations 4 and 5.

$$\begin{matrix}x = x 1 + \frac{R 1 + r 1}{\sqrt{1 + {( \frac{y 1 - q 1}{x 1 - p 1} )}^{2}}} & 4 \\ y = y 1 + ( \frac{y 1 - q 1}{x 1 - p 1} ) \cdot \frac{R 1 + r 1}{\sqrt{1 + {( \frac{y 1 - q 1}{x 1 - p 1} )}^{2}}} & 5\end{matrix}$$

Since the minimum shift distance L1 of the light spot 82 overlapping the region 81 of the iris of the left eye is equal to the distance between the center of the light spot 82 before the shift and the center of the light spot 82 after the shift, the minimum shift distance L1 is calculated according to Equation 6.

$$L 1 = \sqrt{{( x - p 1 )}^{2} + {( y - q 1 )}^{2}} = \sqrt{\begin{matrix}{( x 1 + \frac{R 1 + r 1}{\sqrt{1 + {( \frac{y 1 - q 1}{x 1 - p 1} )}^{2}}} - p 1 )}^{2} + \\ {( y 1 + ( \frac{y 1 - q 1}{x 1 - p 1} ) \cdot \frac{R 1 + r 1}{\sqrt{1 + {( \frac{y 1 - q 1}{x 1 - p 1} )}^{2}}} - q 1 )}^{2}\end{matrix}} \qquad 6$$

The minimum shift distance L2 of the light spot 84 illustrated in FIG. 6 and overlapping the region 83 of the iris of the right eye is calculated according to Equation 7.

$$L 2 = \sqrt{{( x - p 2 )}^{2} + {( y - q 2 )}^{2}} = \sqrt{\begin{matrix}{( x 2 + \frac{R 1 + r 2}{\sqrt{1 + {( \frac{y 2 - q 2}{x 2 - p 2} )}^{2}}} - p 2 )}^{2} + \\ {( y 2 + ( \frac{y 2 - q 2}{x 2 - p 2} ) \cdot \frac{R 2 + r 2}{\sqrt{1 + {( \frac{y 2 - q 2}{x 2 - p 2} )}^{2}}} - q 2 )}^{2}\end{matrix}} \qquad 7$$

Return to FIG. 8. After S201, the determiner 14 compares the minimum shift distance L1 of the light spot 82 overlapping the region 81 of the iris of the left eye with the minimum shift distance L2 of the light spot 84 overlapping the region 83 of the iris of the right eye. Then, the determiner 14 determines whether or not L1 is equal to or smaller than L2 (in S202).

If the determiner 14 determines that L1 is equal to or smaller than L2 (Yes in S202), the calculator 16 calculates, based on L1, a shift vector of the light spot 82 overlapping the left eye (in S203). The shift vector of the light spot 82 may be expressed by (Δp, Δq). By substituting Equations 4 and 5 into Equation 1, Δp and Δq may be calculated according to Equations 8 and 9.

$$\begin{matrix}Δ p = x 1 + \frac{R 1 + r 1}{\sqrt{1 + {( \frac{y 1 - q 1}{x 1 - p 1} )}^{2}}} - p 1 & 8 \\ Δ q = y 1 + ( \frac{y 1 - q 1}{x 1 - p 1} ) \cdot \frac{R 1 + r 1}{\sqrt{1 + {( \frac{y 1 - q 1}{x 1 - p 1} )}^{2}}} - q 1 & 9\end{matrix}$$

If the determiner 14 determines that L1 is larger than L2 (No in S202), the calculator 16 calculates, based on L2, a shift vector of the light spot 84 overlapping the right eye (in S204).

Regarding the light spot 84 overlapping the region 83 of the iris of the right eye, x and y may be expressed by Equations 10.

x=p2+Δp, y=q2+Δq 10

When the equations are solved using the same method as that used for the light spot 82 overlapping the region 81 of the iris of the left eye, x and y are calculated according to Equations 11 and 12.

$$\begin{matrix}x = x 2 + \frac{R 1 + r 2}{\sqrt{1 + {( \frac{y 2 - q 2}{x 2 - p 2} )}^{2}}} & 11 \\ y = y 2 + ( \frac{y 2 - q 2}{x 2 - p 2} ) \cdot \frac{R 2 + r 2}{\sqrt{1 + {( \frac{y 2 - q 2}{x 2 - p 2} )}^{2}}} & 12\end{matrix}$$

By substituting Equations 11 and 12 into Equation 10, an x coordinate Δp of the shift vector and a y coordinate Δq of the shift vector are calculated according to Equations 13 and 14.

$$\begin{matrix}Δ p = x 2 + \frac{r 2 + R 2}{\sqrt{1 + {( \frac{y 2 - q 2}{x 2 - p 2} )}^{2}}} - p 2 & 13 \\ Δ q = y 2 + ( \frac{y 2 - q 2}{x 2 - p 2} ) \cdot \frac{R 2 + r 2}{\sqrt{1 + {( \frac{y 2 - q 2}{x 2 - p 2} )}^{2}}} - q 2 & 14\end{matrix}$$

In the aforementioned manner, the mobile device 100 may execute the process of S108.

Return to FIG. 4. After S108, the image controller 17 moves the specified regions 73 of the displayed guide image 72 based on the shift vector calculated in S108 in order to avoid the overlapping of one of the regions of the irises and the light spots (in S109).

The relationship between the image captured by the imager 30 and the image displayed on the screen is described below.

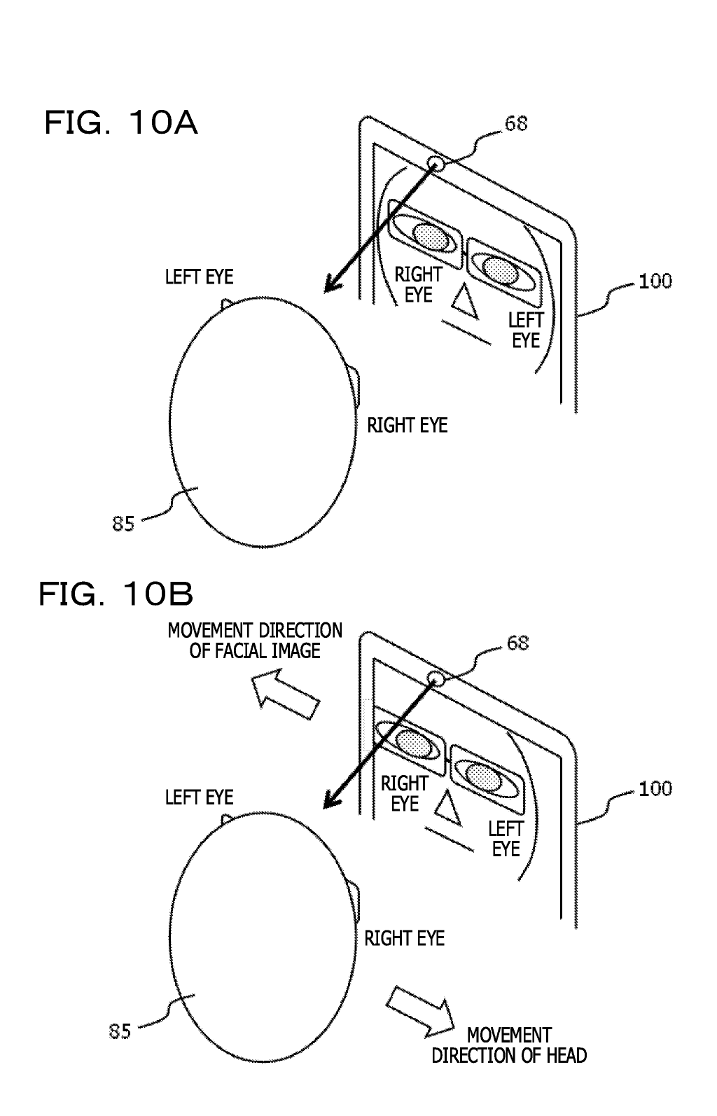

FIGS. 10A and 10B are diagrams illustrating states in which a user's facial image captured by the infrared camera is displayed on the screen. FIGS. 10A and 10B do not illustrate the guide image 72 for convenience sake. As illustrated in FIG. 10A, when the image captured by the infrared camera 68 and indicating the face of the user 85 is displayed on the screen without a change, the right eye of the user 85 among the two eyes displayed on the screen is displayed as a left eye, and the left eye of the user 85 among the two eyes displayed on the screen is displayed as a right eye. Specifically, the eyes of the user 85 are displayed at opposite positions in a horizontal direction. In this case, as illustrated in FIG. 10B, when the user 85 moves the head of the user 85 toward the right direction with respect to the screen in a state in which the position of the mobile device 100 is fixed, the image of the face on the screen is moved toward a direction opposite to the direction toward which the head is moved or the image of the face on the screen is moved toward the left direction. Thus, if the user 85 tries to readjust the positions of the displayed eyes to the specified regions within the guide image 72 after a movement of the displayed guide image 72, the readjustment may not be easy.

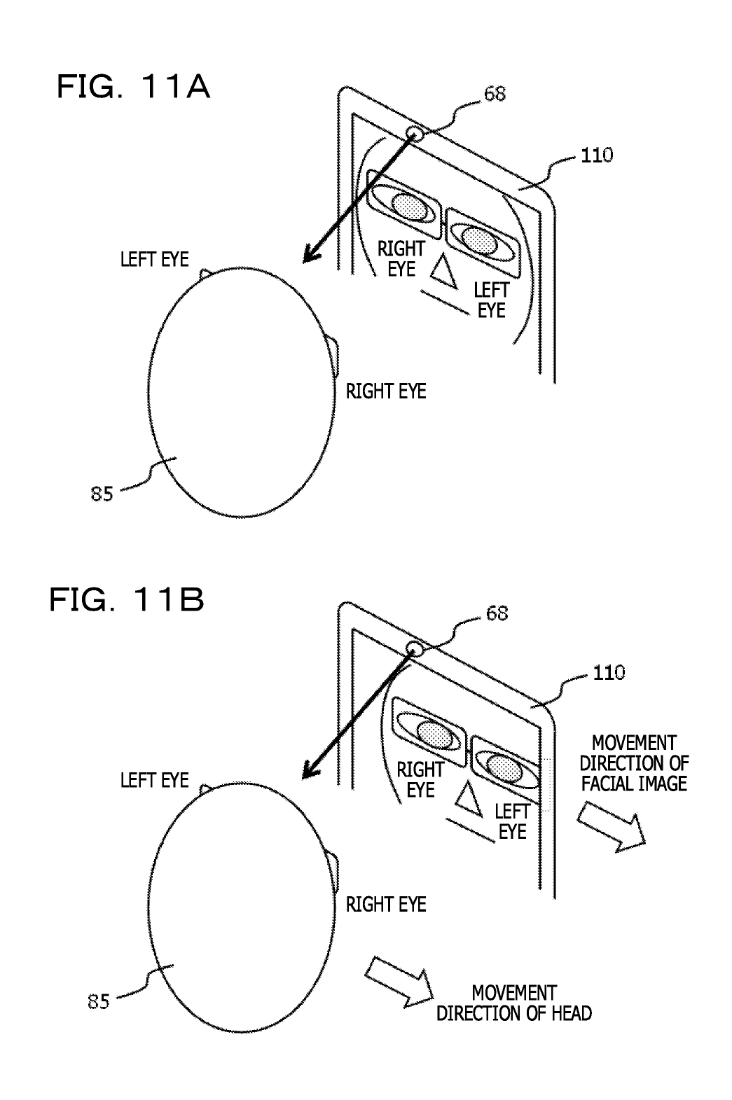

FIGS. 11A and 11B are diagrams states in which a user's facial image captured by the infrared camera is displayed on the screen in the first embodiment. FIGS. 11A and 11B do not illustrate the guide image 72 for convenience sake. As illustrated in FIG. 11A, in the first embodiment, the image captured by the infrared camera 68 and indicating the face of the user 85 is mirror reversed and displayed on the screen. Thus, as illustrated in FIG. 11B, when the image captured by the infrared camera 68 and indicating the face of the user 85 is displayed without a change, the right eye of the user 85 among the two eyes displayed on the screen is displayed as a right eye, and the left eye of the user 85 among the two eyes displayed on the screen is displayed as a left eye. When the user 85 moves the head of the user 85 toward the right direction with respect to the screen in a state in which the position of the mobile device 100 is fixed, the image of the face on the screen is moved toward the same direction as the direction toward which the head is moved or the image of the face on the screen is moved toward the right direction.

In the first embodiment, the image captured by the infrared camera 68 and indicating the face of the user 85 is mirror reversed and displayed on the screen. According to this method, even if the user tries to adjust the positions of the displayed eyes to the specified regions of the guide image after a movement of the displayed guide image, the user may intuitively easily adjust the positions of the displayed eyes to the specified regions of the guide image. The process of S109 is described below.

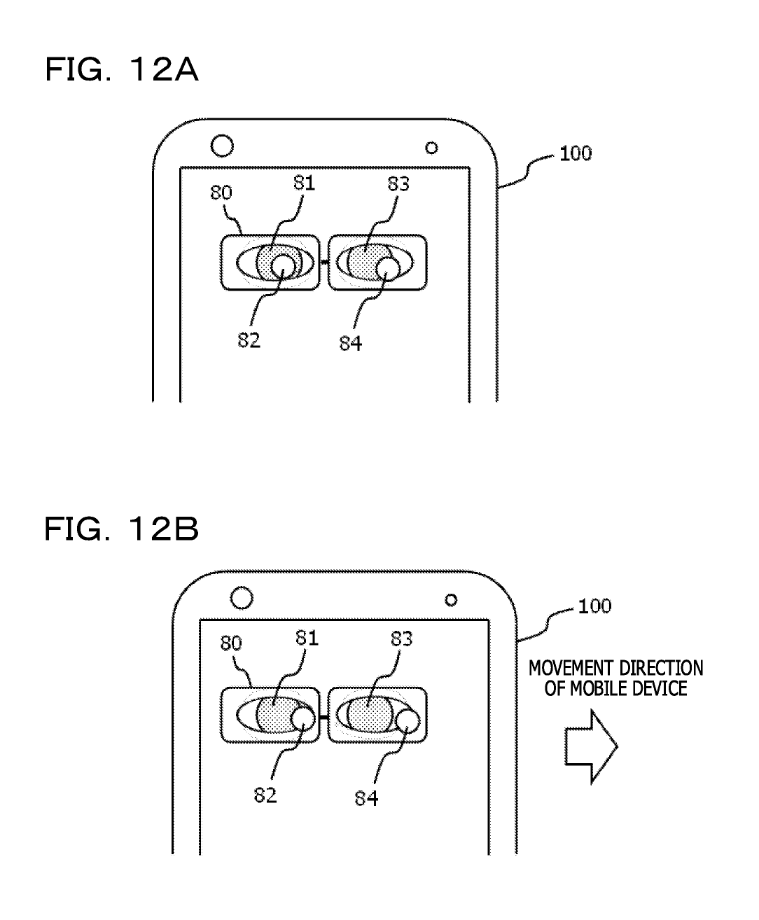

FIGS. 12A and 12B are diagrams illustrating shifts of the light spots on the screen when the mobile device is moved. FIGS. 12A and 12B do not illustrate the guide image 72 for convenience sake. FIG. 12A illustrates a state before the mobile device 100 is moved. FIG. 12B illustrates a state after the mobile device 100 is moved. When the user wearing the glasses 80 moves the mobile device 100 toward the right direction from the state illustrated in FIG. 12A while fixing the positions of the eyes, the light spots 82 and 84 reflected in the lenses of the glasses are shifted toward the right direction with respect to the positions of the displayed eyes, as illustrated in FIG. 12B. The process of S109 uses this feature to promote changes in relative positions of the mobile device 100 and the face of the user with respect to each other in order to avoid the overlapping of one of the eyes and the light spots. In S109, as a process of promoting the changes in the relative positions, a process of moving the guide image 72 displayed on the screen is executed.

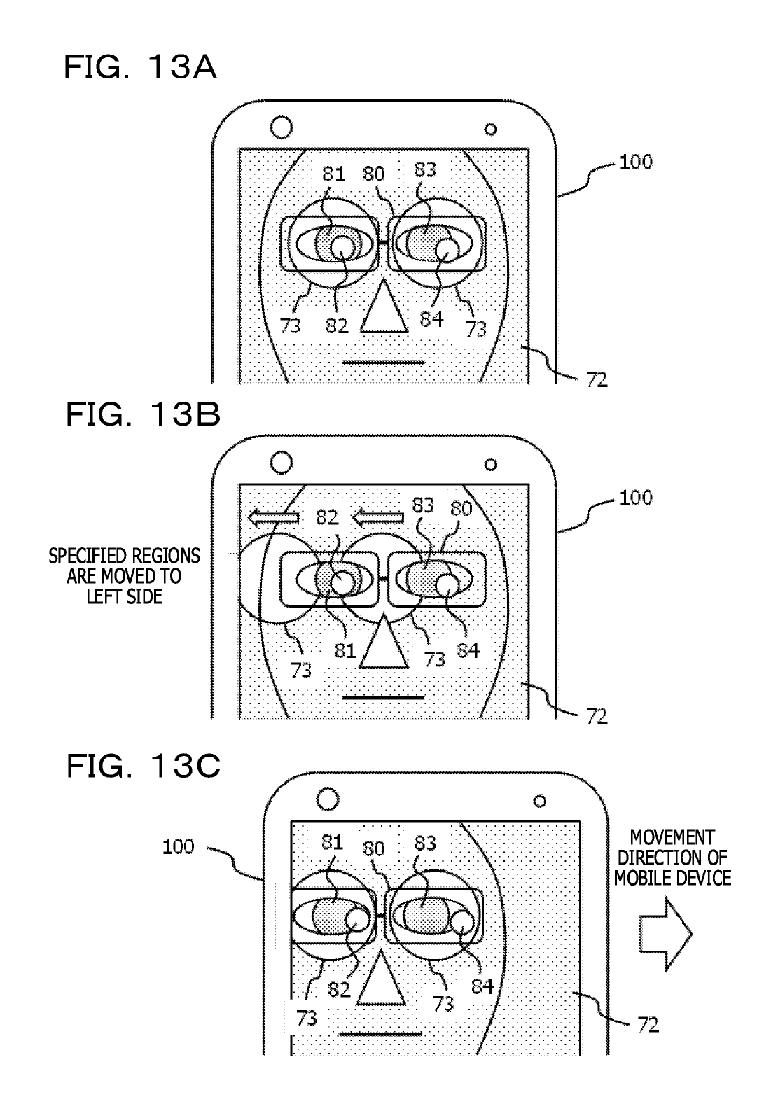

FIGS. 13A, 13B, and 13C are diagrams illustrating an example of shifts of the light spots when the specified regions of the displayed guide image are moved in S109. FIG. 13A illustrates a state before the specified regions 73 of the displayed guide image 72 are moved. FIG. 13B illustrates a state during the time when the specified regions 73 of the displayed guide image 72 are moved. FIG. 13C illustrates a state after the specified regions 73 of the displayed guide image 72 are moved. The following description assumes that shift vectors are oriented toward the right direction.

As illustrated in FIG. 13A, before the movements, both eyes of the user are displayed in the specified regions 73. As illustrated in FIG. 13B, while the positions of the eyes are fixed at positions illustrated in FIG. 13A, the specified regions 73 are moved toward a direction opposite to the orientations of the shift vectors or are moved toward the left direction. In this case, movement distances of the specified regions 73 are determined by multiplying the shift vectors calculated in S108 by a predetermined coefficient. The minimum movement distances of the specified regions 73 that avoid the overlapping of one of the eyes and the light spots depend on optical characteristics such as the refractive index and magnification of the infrared camera 68 and optical characteristics such as the refractive index of the glasses of the user. Thus, instead of the predetermined coefficient, different coefficients may be set for users or types of glasses.

When the specified regions 73 are moved toward the left direction, the eyes of the user are removed from the specified regions 73, as illustrated in FIG. 13B. Thus, while fixing the position of the head of the user, the user tries to readjust the positions of the eyes to the specified regions 73 and moves only the mobile device 100 toward a direction opposite to a direction toward which the specified regions 73 are moved or moves only the mobile device 100 toward the right direction. Then, as illustrated in FIG. 13C, both eyes of the user are displayed in the specified regions 73 of the guide image 72 again. Then, the light spots 82 and 84 reflected in the lenses of the glasses 80 are shifted toward the same direction as the movement direction of the mobile device 100 or are shifted toward the right direction. Then, the light spot 84 among the light spots 82 and 84 does not overlap the region 83 of the iris of the right eye, or the light spots 82 and 84 may not overlap the regions 81 and 83 of the irises. Thus, the probability of recognizing the iris of the right eye is improved, and an effect that is caused by the light spots and is a cause of the failure of the iris authentication may be removed. By moving the specified regions 73 of the displayed guide image 72 based on the shift vectors, movement distances of the specified regions 73 may be suppressed to the minimum distances.

After S109, the process returns to S102 and the iris authentication process is executed again.

In the aforementioned manner, the authentication process is executed by the mobile device 100.

According to the first embodiment, if light spots included in an image overlap regions of the irises of the user, the displayed guide image specifying the positions of the eyes on the screen is moved. According to this method, even if the regions of the irises and the light spots overlap and are displayed on the screen, a movement of the mobile device 100 avoids the overlapping of the regions of the irises and the light spots. Thus, the authentication may be executed with high accuracy without depending on a location at which the iris authentication is executed.

### Second Embodiment

Next, a second embodiment is described. In the first embodiment, the shift vectors of the light spots that are oriented in parallel to the direction from the centers of the regions of the irises to the centers of the light spots are calculated. On the other hand, in the second embodiment, directions of shift vectors are fixed to a direction parallel to a predetermined coordinate axis extending in the direction in which the screen extends.

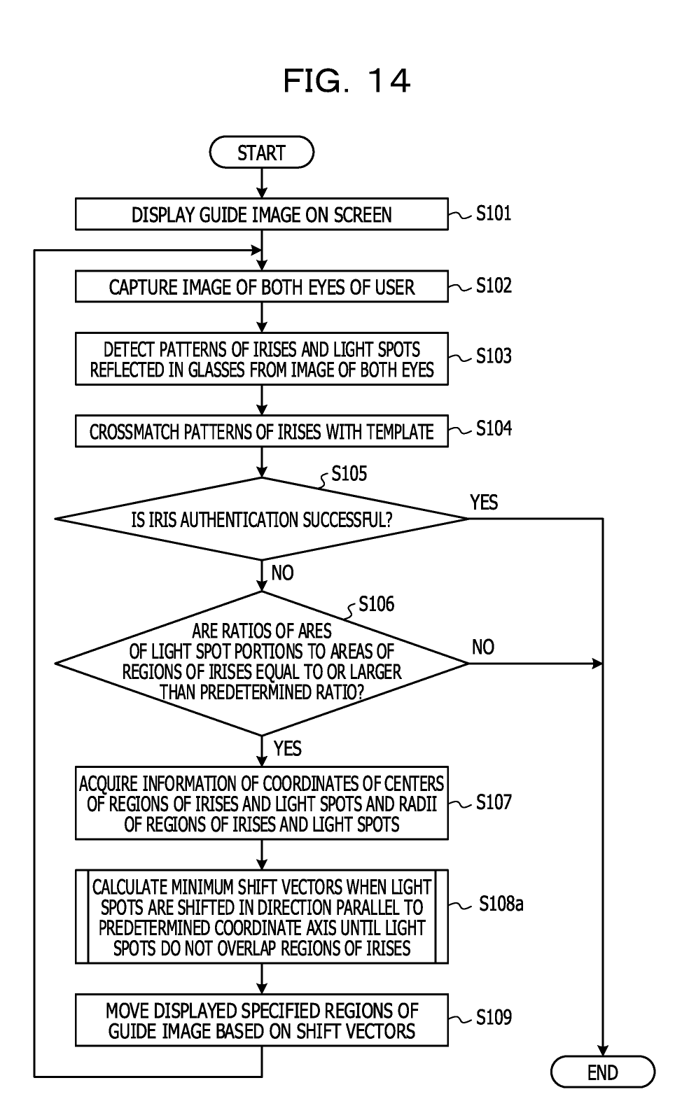

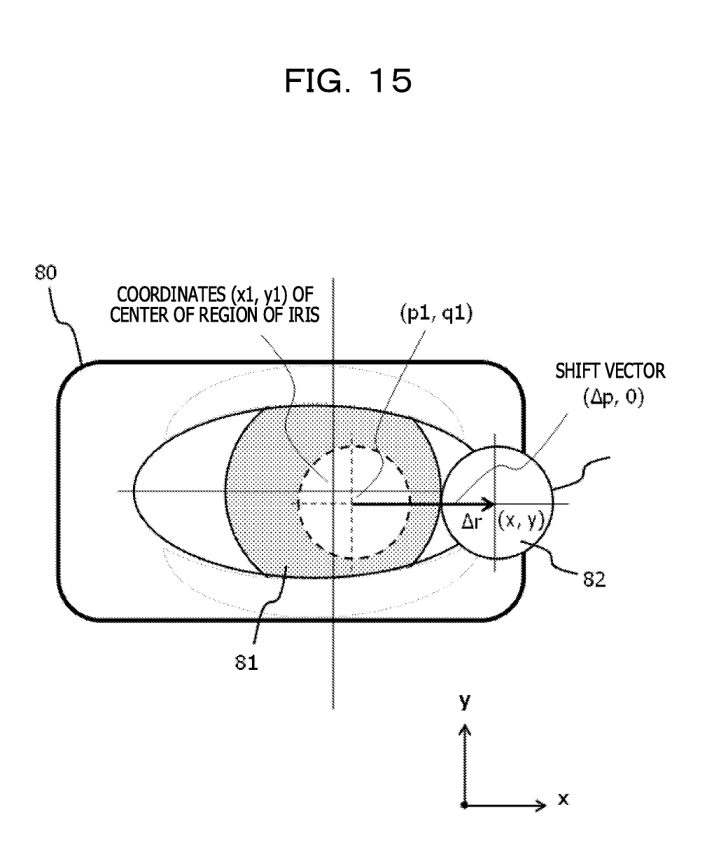

The second embodiment is described below with reference to FIGS. 14 and 15. A mobile device according to the second embodiment is indicated by 100a. A functional block diagram of the mobile device 100a is the same as or similar to that of the mobile device 100 illustrated in FIG. 1 according to the first embodiment, and a description thereof is omitted. A hardware configuration diagram of the mobile device 100a is the same as or similar to that of the mobile device 100 illustrated in FIG. 2 according to the first embodiment, and a description thereof is omitted.

FIG. 14 is a flowchart of an example of an iris authentication method according to the second embodiment.

First, processes that are the same as those of S101 to S107 are executed.

After the process of S107, the calculator 107 uses the information acquired by the region information acquirer 15 and indicating the coordinates and the radii to calculate the minimum shift vectors of the light spots when the light spots overlapping the regions of the irises are shifted in a direction parallel to the predetermined coordinate axis until the light spots do not overlap the regions of the irises (in S108a). A method of calculating a shift distance of the light spot overlapping the region of the iris of the right eye using parameters of coordinates and radii is described below. An example in which the direction of a shift vector is fixed to a direction parallel to an x axis is described below.

FIG. 15 is a diagram describing the method of calculating a shift distance of a light spot according to the second embodiment. FIG. 15 illustrates an image displayed on the screen of the display section 50 of the mobile device 100a and indicating the left eye. FIG. 15 illustrates a state in which the light spot 82 is shifted by the minimum shift distance from the state illustrated in FIG. 6 until the light spot 82 does not overlap the 82 of the iris and becomes externally tangent to the region 81 of the iris. The light spot 82 before the shift is indicated by a dotted line. Coordinates of the center of the region 81 of the iris are (x1, y1), while coordinates of the center of the light spot 82 before the shift are (p1, q1). Coordinates of the center of the light spot 82 after the light spot 82 is shifted by the minimum shift distance are (x, y). The description with reference to FIG. 15 assumes that, in an xy coordinate system having its origin at the center of the region 81 of the iris, the light spot 82 is shifted in an x-axis positive direction in the fourth quadrant of the xy coordinate system. Specifically, it is assumed that x>p1>x1 and y=q1<y1.

As illustrated in FIG. 15, if a shift distance of the light spot 82 in the x axial direction is Δr, a shift vector of the light spot 82 may be expressed by (Δr, 0). In this case, x and y may be expressed by Equations 15.

x=p1+Δr, y=q1 15

The shift distance of the light spot 82 when the light spot 82 overlapping the region 81 of the iris is shifted until the light spot 82 does not overlap the region 81 of the iris is a distance by which the light spot 82 is shifted in a time period from the start of the shift of the light spot 82 to the time when the distance between the center of the region 81 of the iris and the center of the light spot 82 becomes equal to the sum of the radius of the region 81 of the iris and the radius of the light spot 82. In the example illustrated in FIG. 15, a point at which the light spot 82 is externally tangent to the region 81 of the iris exists on a straight line extending between the coordinates (x1, y1) of the center of the region 81 of the iris and the coordinates (x, y) of the center of the light spot 82 after the light spot 82 is shifted by the minimum shift distance. Similarly to Equation 2, the distance between the center of the region 81 of the iris and the center of the light spot 82 after the light spot 82 is shifted by the minimum shift distance may be expressed by Equation 16.

\sqrt{(x−x1)²+(y−y1)²}=R1+r1 16

By substituting x and y of Equation 15 into Equation 16, Equation 17 is established.

\sqrt{(p1+Δr−x1)²+(q1−y1)²}=R1+r1 17

If x>p1>x1 and Equation 17 is modified, Δr is calculated according to Equation 18.

Δr=−p1+x1+\sqrt{(R1+r1)²−(q1−y1)²} 18

The minimum shift distance L1 of the light spot 82 overlapping the region 81 of the iris of the left eye is calculated according to Equation 19.

L1=Δr=−p1+x1+\sqrt{(R1+r1)²−(q1−y1)²} 19

Similarly to the method of calculating L1, the minimum shift distance L2 of the light spot 84 illustrated in FIG. 6 and overlapping the region 83 of the iris of the right eye is calculated as follows.

L2=Δr=−p2+x2+\sqrt{(R2+r2)²−(q2−y2)²} 20

In the aforementioned manner, the mobile device 100a may execute the process of S108.

After the process of S108, processes that are the same as those of S109 and later illustrated in FIG. 4 are executed. If the answer to the determination of S105 is affirmative (or Yes) or if the answer to the determination of S106 is negative (or No), the iris authentication process is terminated.

In the aforementioned manner, the mobile device 100a executes the authentication process.

According to the second embodiment, the directions of the shift vectors are fixed to the direction parallel to the predetermined coordinate axis. Thus, the process of calculating the minimum shift distances of the light spots may be simplified. The example in which the directions of the shift vectors are fixed to the direction parallel to the x axis is described above. The directions of the shift vectors, however, may be fixed to the y axis. If the directions of the shift vectors are fixed to the direction in which the two eyes are displayed side by side or to the direction parallel to the x axis, an operation of the mobile device 100 may be easy for the user who performs the iris authentication while operating the mobile device 100a. It is, therefore, preferable that the directions of the shift vectors be fixed to the direction parallel to the x axis.

Although the embodiments are described above, the present disclosure is not limited to the specific embodiments, and various modifications and changes may be made. The shapes of the light spots are the exact circles in the first and second embodiments. For example, even if the shapes of the light spots may not be the exact circles and may be ellipses, bars, or the like, the disclosure is applicable to the light spots. For example, FIGS. 13A, 13B, and 13C describe the example in which only the light spot 84 is removed from the region 83 of the iris of the right eye, but the specified regions 73 may be moved so that the light spots 82 and 84 are removed from the specified regions 81 and 83 of the irises of both eyes.

The aforementioned mobile devices, a computer program that causes a computer to execute a method of controlling the aforementioned mobile devices, and a non-transitory computer-readable storage medium storing the computer program, are included in the techniques disclosed herein. The non-transitory computer-readable storage medium is a memory card such as an SD memory card, for example. The computer program may not be stored in the storage medium and may be transferred via a network such as a telecommunications line, a wireless communication line, a wired communication line, or the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An authentication method executed by a processor included in a mobile device having a camera, the authentication method comprising:
displaying an image captured by the camera and including irises of a user on a screen of the mobile device based on a position of a displayed guide image specifying positions of eyes;
calculating, based on positional relationships between light spots and the regions of the irises, when the light spots included in the image overlap regions of the irises, shift vectors of the light spots when the light spots are shifted until the light spots do not overlap the regions of the irises; and
moving the displayed guide image in a movement direction determined based on the shift vectors and executing authentication on the user using the irises displayed based on the position of the displayed guide image after the movement of the guide image.

2. The authentication method according to claim 1, further comprising:
calculating areas of the regions of the irises exposed from eyelids and areas of light spot portions included in the light spots and overlapping the regions of the irises;
calculating ratios of the areas of the light spot portions to the areas of the regions of the irises; and
determining that the light spots overlap the regions of the irises when the calculated ratios are larger than a predetermined threshold.

3. The authentication method according to claim 1,
wherein the calculating the shift vectors includes acquiring information of coordinates of centers of the regions of the irises, coordinates of centers of regions of the light spots, radii of the regions of the irises, and radii of the regions of the light spots and using the information of the coordinates of the centers and the radii to calculate the minimum shift vectors of the light spots when the light spots are shifted until the light spots do not overlap the regions of the irises.

4. The authentication method according to claim 1,
wherein the user wears glasses.

5. The authentication method according to claim 1,
wherein the shift vectors have a direction parallel to a predetermined coordinate axis extending in a direction in which the screen extends.

6. The authentication method according to claim 5,
wherein the predetermined coordinate axis is parallel to a straight line included in a contour of the screen.

7. The authentication method according to claim 1,
wherein the moving includes moving the guide image toward a direction opposite to orientations of the shift vectors.

8. The authentication method according to claim 1, further comprising:
calculating an amount of the movement of the guide image by multiplying magnitudes of the shift vectors by a predetermined coefficient,
wherein the moving includes moving, in the movement direction determined based on the shift vectors, the guide image based on the calculated amount of the movement.

9. The authentication method according to claim 1,
wherein the displaying includes mirror reversing and displaying the image.

10. A mobile device comprising:
a camera; and
a processor coupled to the camera and configured to:
display an image captured by the camera and including irises of a user on a screen of the mobile device based on a position of a guide image specifying positions of eyes;
calculate, based on positional relationships between light spots and the regions of the irises, when the light spots included in the image overlap regions of the irises, shift vectors of the light spots when the light spots are shifted until the light spots do not overlap the regions of the irises; and
move the guide image in a movement direction determined based on the shift vectors and executing authentication on the user using the irises displayed based on the position of the guide image after the movement of the guide image.

11. The mobile device according to claim 10, wherein the processor is configured to:
calculate areas of the regions of the irises exposed from eyelids and areas of light spot portions included in the light spots and overlapping the regions of the irises;
calculate ratios of the areas of the light spot portions to the areas of the regions of the irises; and
determine that the light spots overlap the regions of the irises when the calculated ratios are larger than a predetermined threshold.

12. The mobile device according to claim 10, wherein the processor is configured to
acquire information of coordinates of centers of the regions of the irises, coordinates of centers of regions of the light spots, radii of the regions of the irises, and radii of the regions of the light spots and using the information of the coordinates of the centers and the radii to calculate the minimum shift vectors of the light spots when the light spots are shifted until the light spots do not overlap the regions of the irises.

13. The authentication method according to claim 10,
wherein the user wears glasses.

14. A non-transitory computer-readable storage medium storing a program that causes a processor included in a mobile device having a camera to execute a process, the process comprising:
displaying an image captured by the camera and including irises of a user on a screen of the mobile device based on a position of a guide image specifying positions of eyes;
calculating, based on positional relationships between light spots and the regions of the irises, when the light spots included in the image overlap regions of the irises, shift vectors of the light spots when the light spots are shifted until the light spots do not overlap the regions of the irises; and
moving the guide image in a movement direction determined based on the shift vectors and executing authentication on the user using the irises displayed based on the position of the guide image after the movement of the guide image.
